(19) United States
(12) Patent Application Publication
(10) Pub. No.: US 2014/0330740 A1
(43) Pub. Date: Nov. 6, 2014

(54) SYSTEMS AND METHOD FOR COLLECTING AND REDISTRIBUTING SURPLUS ITEMS

(71) Applicants: András Hoffmann, JR., Budapest (HU); Szávó Sztilkovics, Pilisszentivan (HU); Antal Ling, Budapest (HU)

(72) Inventors: András Hoffmann, JR., Budapest (HU); Szávó Sztilkovics, Pilisszentivan (HU); Antal Ling, Budapest (HU)

(21) Appl. No.: 13/887,967

(22) Filed: May 6, 2013

(51) Int. Cl. G06Q 10/08

(52) U.S. Cl. CPC G06Q 10/0836
USPC 705/339

(57) ABSTRACT

A system for distributing surplus items includes the following modules. A central control module distributes the items donated by a donor(s) to a recipient(s) based on a recipient's qualification and an availability of the items. A donor registration module registers the donor. A donor surplus items module registers the availability, characteristics of the items, and a pick-up location on a predetermined time period. A recipient registration module registers the recipient when qualified and parameters associated with the recipient. A donor match module matches the donor with the recipient and selects the items based on the parameters, and generates an approval code and a pick-up location for each item. A search result module notifies the recipient of the items, the pick-up location, and a time limit for responding to the notification and picking up the items, and sends the approval code to the recipient upon a timely positive response.

### FIELD OF THE DISCLOSURE

This disclosure relates to automation systems for the surplus item distributions, and more specifically relates to automation of distribution of surplus food and other products to the needy over a network.

### BACKGROUND OF THE DISCLOSURE

While many restaurants, public kitchens and other vendors produce a considerable amount of unconsumed food products, people in need of nutritious food go hungry every day. It is desirable that cooked perishable food products be redistributed. Thus, a system or a process is needed to help collect such unwanted surplus foodstuffs efficiently from donors and redistribute the foodstuffs to recipients before expiration of the foodstuffs. However, the collection and redistribution of the surplus food items are costly and may involve liability guaranteeing the quality of distributed food items. Additionally, providing pick-up locations and logistics are the responsibilities of the collecting and redistributing entities. Moreover, this collecting and redistributing process may not be able to reach people who are unwilling to publicly disclose themselves due to private reasons.

### SUMMARY OF THE DISCLOSURE

According to the present disclosure, there is provided a collection and distribution system, which features an automation system for acquiring surplus food items using a mobile device having access to a wireless network, such as the Internet. The main feature is that a recipient who wishes to acquire the surplus food items from a donor discretely receives a notification from the system via, e.g., a text message, an email, or other similar electronic communication on the mobile device, without intervention of an external organization.

Another aspect of the system is that the donor, such as a restaurant or an organization, may not only gain tax benefits from the donation but also save operating costs because rather than spending resources on waste management for the surplus food items, an existing network infrastructure and services are used to collect and distribute the surplus food items. Further, the participating restaurants and organizations have control over the quality of the food items because the food items remain on their premise until they are picked up by the recipients. Moreover, because the pick-up transaction is processed in such a discrete way using the recipient's personal mobile device on an as-needed basis, the recipients do not need to be in line in front of a specific restaurant or a known, designated location for receiving the food items. Other patrons only see that the recipient enters the restaurant for picking up a takeout.

Accordingly, the present system mainly targets a social class or group that hides its needs from the society but is willing to accept the donated surplus food items if the transaction can be arranged in a discrete manner. An essential aspect of the present system is that transactional information, such as how many or which recipients were drawn on a given day for the food items, is kept confidential and private so that the recipients can rest assured that their identities are not publicly disclosed. Not only is the present system applicable in large cities, but it can also be implemented in rural regions using, e.g., public kitchens, student or company canteens that can adapt to the present system. In this manner, the present system can also be made suitable for implementation of socio-political actions based on a quantity and a geographical mapping of the food requests received.

Moreover, the present system can be implemented for other purposes, such as for providing free information on an availability of supply organizations; on complimentary consumer goods, clothes, or blankets; on free medical care, vaccination, or screening examinations; on emergency broadcast information (e.g., frost, flood, hurricane, extreme heat, etc.); on possibilities for casual labor; on social and municipal assistance programs; on an availability of self-supporting groups and programs; on free or inexpensive communal or cultural programs; or on legal assistance services. Additionally, users of the present system can evaluate and express their opinions concerning the operation of the present system through blogging or casting votes on any relevant topics.

Accordingly, the present system helps socially displaced recipients rejoin the social circulation, and strengthen their self-esteem and consciousness; and promotes the development and maintenance of a less-wasting and more solidary social system. This results in a concrete physical advantage in a society while the users are also psychically strengthened by expressing their opinions through the present system. Thus, by casting their votes and participating in a decision-making process, they can be persuaded to return to the society for a better future.

In one embodiment, a system for collecting and distributing one or more surplus items is provided that includes a central control module for distributing the surplus items donated by at least one donor to at least one recipient based on a recipient's qualification and an availability of the surplus items. A donor registration module registers the donor. A donor surplus items module registers the availability of the surplus items, characteristics of the surplus items, and a pick-up location of the surplus items on a predetermined time period. A recipient registration module registers the recipient when qualified and a plurality of parameters associated with the recipient. A donor match module matches the donor with the recipient and selects the surplus items based on the parameters, and then generates an approval code and a pick-up location for each surplus item. A search result module notifies via a network the recipient of the surplus items, the pick-up location, and a predetermined time limit within which the recipient is allowed to respond to the notification and pick up the surplus items. After the recipient positively responds to the notification within the time limit for accepting the surplus items, the approval code is sent to the recipient.

In another embodiment, a method for collecting and distributing one or more surplus items is provided that includes distributing the surplus items donated by at least one donor to at least one recipient based on a recipient's qualification and an availability of the surplus items; registering the donor, the availability of the surplus items, characteristics of the surplus items, and a pick-up location of the surplus items on a predetermined time period; registering the recipient when qualified and a plurality of parameters associated with the recipient; matching the donor with the recipient and selecting the surplus items based on the parameters; generating an approval code and a pick-up location for each surplus item; and notifying, via a network, the recipient of the surplus items, the pick-up location, and a predetermined time limit within which the recipient is allowed to respond to the notification and pick up the surplus items, wherein the approval code is sent to the recipient after the recipient positively responds to the notification within the time limit.

The foregoing and other aspects and features of the disclosure will become apparent to those of reasonable skill in the art from the following detailed description, as considered in conjunction with the accompanying drawings.

### BRIEF DESCRIPTION OF THE DRAWINGS

FIG. 1 illustrates an environment for an exemplary collection and distribution system in accordance with an embodiment of the present disclosure.

FIG. 2 is a functional block diagram of the collection and distribution system shown in FIG. 1.

FIGS. 3A-3B illustrate an exemplary collection and distribution method in accordance with an embodiment of the present disclosure.

### DETAILED DESCRIPTION OF THE PREFERRED EMBODIMENTS

Preferred embodiments of the present disclosure are described below by way of example only, with reference to the accompanying drawings. Further, the following description is merely exemplary in nature and is in no way intended to limit the disclosure, its application, or uses. As used herein, the term “module” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality. Although the children modules residing in their respective parent modules are shown, the broad teachings of the present system can be implemented in a variety of forms. Thus, while this disclosure includes particular examples and arrangements of the modules, the scope of the present system should not be so limited since other modifications will become apparent to the skilled practitioner.

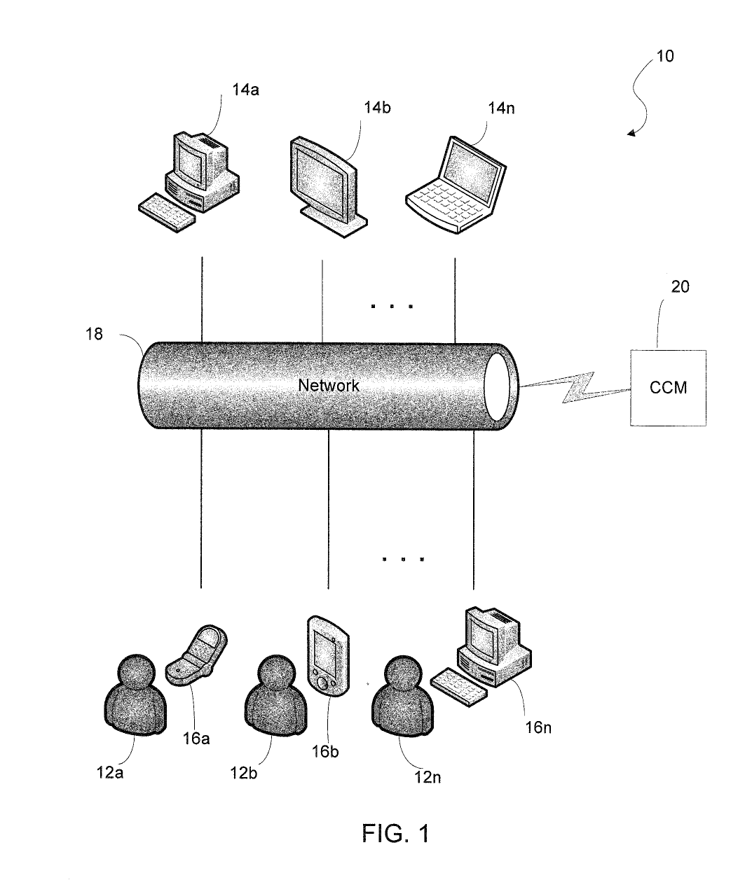

Referring now to FIG. 1, an exemplary system for collecting and distributing one or more surplus food items is schematically illustrated and generally designated 10. The system 10 enables one or more qualified recipients 12 to collect surplus food items donated by one or more donors 14, using the recipients' devices 16 having access to a network 18. Any type of computer network having a collection of computers and other hardware interconnected by communication channels is contemplated, such as the Internet, Ethernet, LAN, GAN, etc. Similarly, any type of computing device is contemplated, such as a cell phone, a mobile device, a laptop, a desktop, etc. Further, it is contemplated that while the surplus food items are discussed in one embodiment, the present system can be implemented for other types of surplus products, e.g., clothing, furniture, appliances, etc.

Included in the system 10 is a central control module (CCM) 20, which regulates operation of the system 10. The system 10 operates as either a push system or a pull system. The push system refers to a system where the CCM 20 pushes information about the surplus food items or other related information directly to the recipients 12 without the recipients' requests. On the other hand, the pull system refers to a system where the recipients actively ask for the surplus food items and pull the information about the surplus food items as needed.

As an example for the push system, donors 14 upload data on surplus food items. The CCM 20 selects a recipient for each item by lottery or other criteria based on pre-stored information, such as a recipient's qualification and location. The recipient's qualification is determined based on various predetermined values, such as an income level, an amount of savings, a preexisting assets, etc. As an example, the recipient's qualification can be derived from a government issued identifier, such as a “Food Stamp” account number, because the account number indicates that the recipient has already satisfied a state-ruled qualification examination. The recipient's location is determined based on the recipient's home address or current location. Optionally, in lieu of the recipient's home address or name, the government issued identifier is used to anonymously register the recipient into the system 10. In this way, anonymity of the recipient is maintained during normal operation.

For the pull system, recipients 12 send food requests FD_{REQ} to the CCM 20 via devices 16. The CCM 20 selects surplus food items (previously uploaded and stored) based on the food request FD_{REQ}. After the selection process, in the push or pull system, the CCM 20 sends a notification to the recipient 12 about the surplus food items, a pick-up location for the items, and a time limit for responding to the notification and picking up the items. After the recipient 12 positively responds to the notification within the time limit, e.g., 5 minutes, an approval code APV is sent to the recipient's device 16a. By providing the approval code APV to the donor 14a, the recipient 12a can pick up the selected food items within the time limit. The CCM 20 is explained in greater detail below.

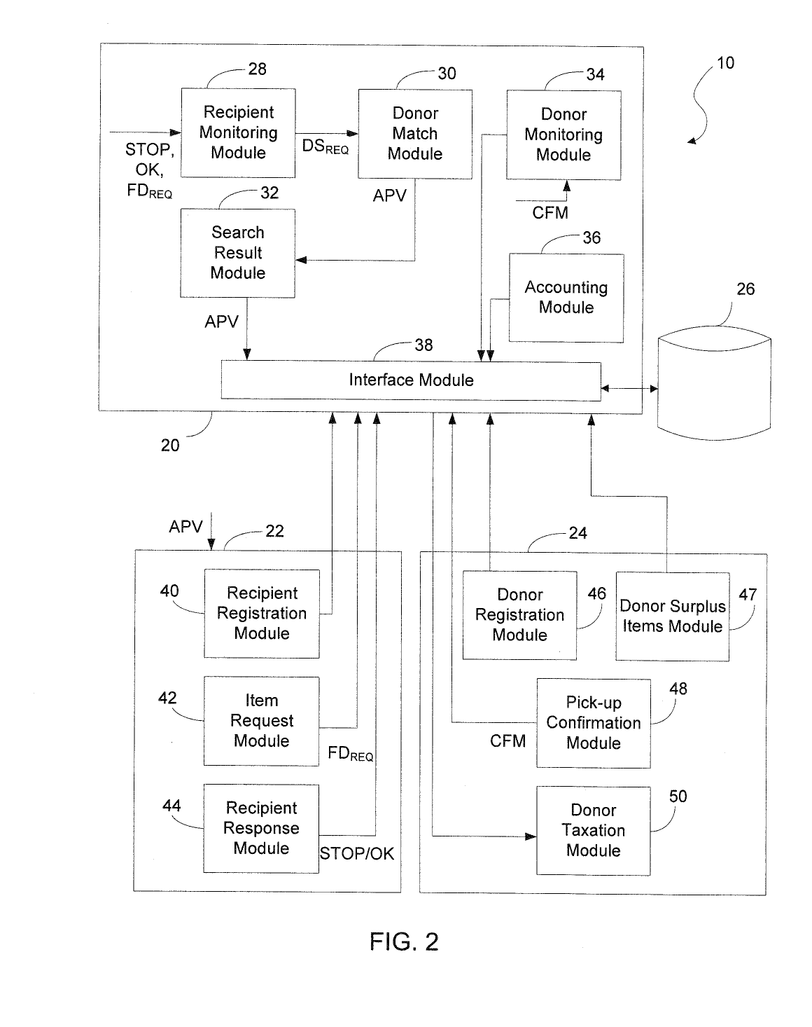

Referring now to FIGS. 1-2, it is preferred that the system 10 uses the CCM 20, a recipient module 22, a donor module 24, and a central database 26. All relevant information can be stored in the central database 26 for retrieval by the CCM 20, e.g., a data storage device and/or a machine readable data storage medium carrying computer programs. The CCM 20 includes a recipient monitoring module 28, a donor match module 30, a search result module 32, a donor monitoring module 34, an accounting module 36, and an interface module 38. The recipient module 22 includes a recipient registration module 40, an item request module 42, and a recipient response module 44. The donor module 24 includes a donor registration module 46, a donor surplus items module 47, a pick-up confirmation module 48, and a donor taxation module 50.

The interface module 38 provides an interface between the CCM 20, the recipient module 22, the donor module 24, and the central database 26. The interface module 38 controls operation of, for example, the devices 16, the network 18, and other related system devices, services, and applications. The other devices, services, and applications may include, but are not limited to, one or more software or hardware components, etc. The interface module 38 also receives signals, which are communicated to the respective modules, such as the CCM 20, the recipient module 22, the donor module 24.

In general, the CCM 20 distributes the surplus food items donated by one or more donors 14 to one or more recipients 12 when the recipients are qualified to collect the available food items. Both the recipients 12 and the donors 14 simultaneously or independently preregister before the food items are selected for distribution. For example, the recipient registration module 40 registers information about the recipients 12, such as a recipient's address, a recipient's phone number, a recipient's email/electronic address, a recipient's name, a recipient's government issued identifier (e.g., a “Food Stamp” account number, a social security account number, and the like), and a recipient's mobile device geographical positioning information. For example, a global positioning system (GPS) can be used to retrieve location and time information in real time. While such a precise GPS location is preferred, an exact address of the recipient 12 is not required. A location describing metes and bounds of the recipient's position relative to identifiable surrounding objects satisfies the address requirement, e.g., 50-100 yard diameter from a specific position. Further, various parameters associated with the recipient are registered. The parameters are set based on at least one of dietary, belief-based, and medical reasons. For example, the recipient 12 can request for foods free of meat or ask for special restrictions on the ingredients based on religious reasons.

Similarly, the donor registration module 46 registers information about the donors 14, such as a donor's address, a donor's phone number, a donor's name, and a government issued identifier, such as a tax identification number or a federal taxpayer identification number. Further information is separately uploaded from the registration, e.g., daily, such as characteristics of the surplus food items, and a pick-up location(s), availability of specific food items and associated quantity. Specifically, the donor surplus items module 47 recurrently uploads and stores such information about the surplus food items whenever the donors 14 have surplus food items available for distribution.

For such distribution, the donor match module 30 searches for the recipients 12 based on the parameters that match the characteristics of the food items, a predetermined distance between the recipient 12 and the donor 14, and a priority level associated with the recipient. For example, the donor match module 30 selects only the recipients 12 that are located within a radius of 5-10 minute walking distance from the donor's location. The donor's location refers to either the donor's registered address or the pick-up location. The distance is measured from either the recipient's registered address or a current GPS location of the recipient's device 16.

In case that too many recipients 12 exist within the predetermined distance, the selection process can be weighted. For example, the donor match module 30 executes a lottery-type draw to select a predetermined number of recipients 12 based on the recipient's priority level. The priority level is determined based on at least one of a physical condition and a number of family members and/or dependents of the recipient. For example, the recipient selection process can be weighted by granting a higher priority to the recipient 12 with disabilities or a large family. Multiple food items from multiple donors 14 can be provided to the recipient 12 depending on the number of the family members and/or dependents. Other factors are contemplated in determining the recipient's priority level. For example, the priority level is determined based on historical behaviors of the recipient 12. More specifically, when the recipient 12 fails to appear before the pick-up location of the accepted surplus items for more than predetermined times, the recipient's priority level is accordingly weighted and ranked lower than a previously held priority level.

Alternatively, in the pull system, the item request module 42 generates a food request FD_{REQ} having the parameters based on dietary, belief-based, and medical reasons, The recipient monitoring module 28 receives the food request FD_{REQ} from the recipients 12. Each food request has various parameters associated with the recipient 12. Then, the recipient monitoring module 28 generates a donor search request DS_{REQ} based on the food request FD_{REQ}, and transmits the donor search request DS_{REQ} to the donor match module 30. The donor match module 30 receives the donor search request DS_{REQ} from the recipient monitoring module 28, searches for the donors 14 based on the food request FD_{REQ}, the predetermined distance between the recipient 12 and the donor 14, and the priority level associated with the recipient.

After completing the matching process, either in the push or pull systems, the donor match module 30 generates the approval code APV and an associated pick-up location or address for each corresponding surplus food item. For example, when the recipient 12 is eligible for collecting three food items based on the number of family members, three different approval codes APV are transmitted to the search result module 32. Accordingly, the search result module 32 notifies the recipient 12 of the surplus food item, the pick-up location(s), and a predetermined time limit, e.g., 5 minutes, for responding to the notification and optionally for picking up the item via the network 18. Additional related information, such as descriptions of the food items, map information and pictures of the pick-up location, can be generated for transmission. The recipient 12 has an option to respond positively (i.e., to accept one or more items) or negatively (i.e., to reject one or more items). After the recipient 12 positively responds to the notification within the time limit, the approval code(s) APV for accepted items is sent to the recipient. If the recipient 12 negatively responds to the notification, or fails to respond to the notification within the time limit, then rejected items become available for reassignment.

More specifically, the recipient response module 44 generates a cancel signal STOP to cancel the approval code APV when the recipient 12 rejects the selected surplus food items. For example, if the recipient 12 does not wish to acquire or cannot pick-up the selected surplus food items, the recipient 12 can notify the CCM 20 by transmitting a text message “STOP.” Then, the recipient monitoring module 28 receives the cancel signal STOP and resets the approval code APV for the selected surplus food items, and sets the selected surplus food items as available for subsequent food requests.

When the approval code APV is sent to the recipient 12, another time limit, e.g., 15 minutes, may be associated with picking up the accepted items at the pick-up location. If the accepted items are not picked up within the time limit by the recipient 12 or anyone with the approval code APV, or alternatively the donor 14 rejects such a person who appears to pick up the accepted items, then the approval code APV is canceled and the items become available for reassignment.

The pick-up confirmation module 48 generates the confirmation signal CFM that confirms a pick-up of the selected surplus food items by the recipient 12 based on the approval code APV. For example, the recipient 12 presents the approval code APV to the donor 14 when picking up the food items at the pick-up location. The donor 14 hands over the food items to the recipient 12, and sends back the approval code APV to the CCM 20 via the network 18. Specifically, the pick-up confirmation module 48 transmits the approval code APV to the donor monitoring module 34 as the confirmation signal CFM. Thus, the confirmation signal CFM can be the same approval code APV or a different code depending on its use. The donor monitoring module 34 receives a confirmation signal CFM from the pick-up confirmation module 48, and sets the selected surplus food items as unavailable for a subsequent food request.

Additionally, the donor match module 30 can search for other available surplus food items based on the predetermined parameters, and generate another approval code APV and an associated pick-up location or address for each different corresponding surplus food item. The recipient 12 has the option to selectively reject the approval code APV associated with each selected surplus item, or to simply not respond to the notification of the approval code, if the recipient is not satisfied with the selected item(s).

The accounting module 36 collects historical pick-up transactions of the donors 14 that were recorded in the central database 26 by the CCM 20. Then, the accounting module 36 determines an amount of tax benefits for the donor 14 based on various parameters, e.g., at least one of a number of the pick-up transactions, a predetermined value of the selected surplus food items, and a multiplication of the number of the transactions and the predetermined value. Each parameter is associated with a corresponding donor 14.

The donor taxation module 50 regularly applies the amount of tax benefits for the donor 14 over a predetermined period. For example, the donor taxation module 50 receives the amount of tax benefits from the accounting module 36 based on historical transaction summary information compiled by the accounting module 36. This calculated tax benefit amount can be applied to the donor's income tax as an eligible deduction or write-off on a monthly, quarterly, or yearly basis. For example, a financial report on the tax benefit is sent to a designated organization, such as a charity organization.

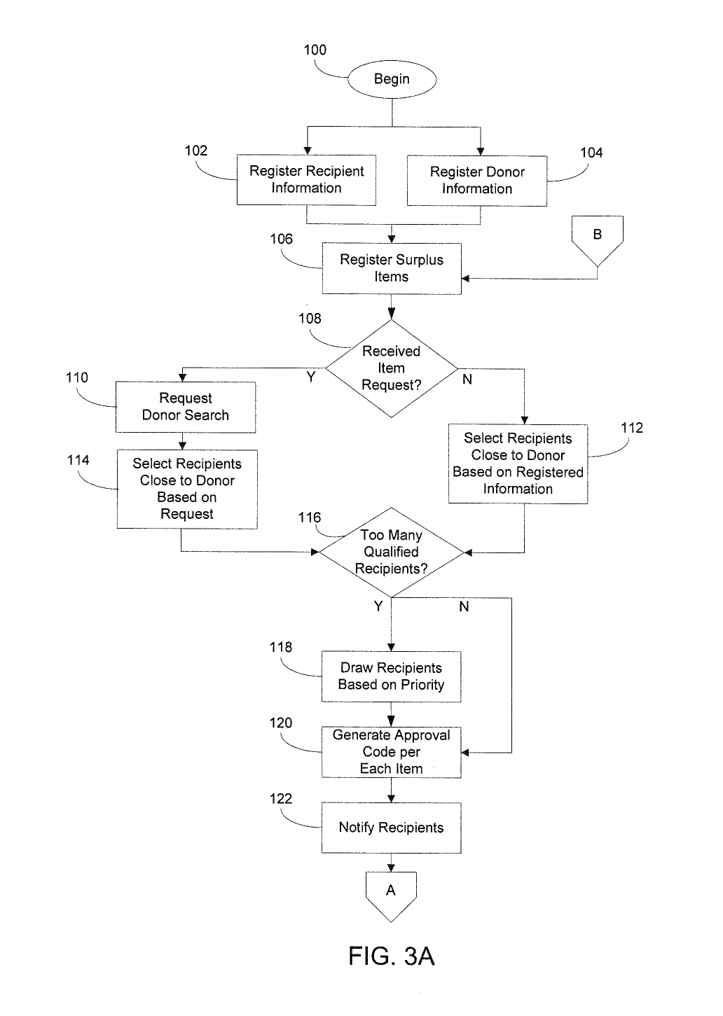

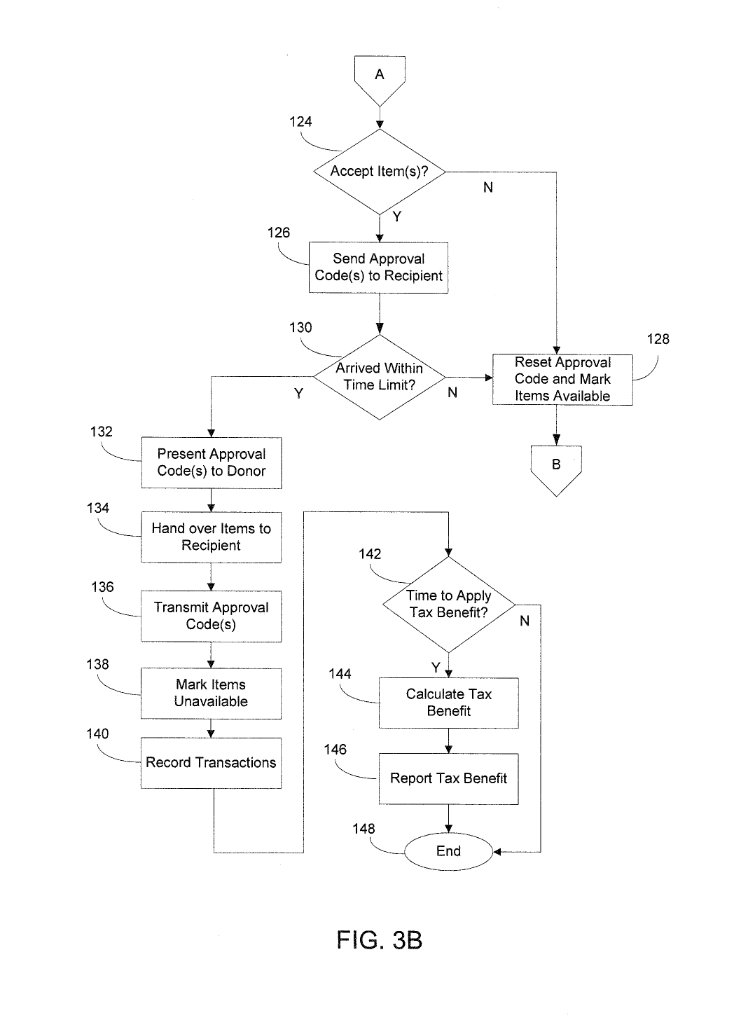

Referring now to FIGS. 3A-3B, an exemplary method for collecting and distributing one or more surplus food items is shown. Although the following steps are primarily described with respect to the embodiments of FIGS. 1-2, it should be understood that the steps within the method may be modified and executed in a different order or sequence without altering the principles of the present disclosure.

The method begins at step 100. In step 102, the recipient registration module 40 registers information about the recipients 12, such as the address, the phone number, the name, the parameters based on dietary, belief-based, and medical reasons. It is contemplated that verified government issued identifiers, such as a social security account number or “Food Stamp” account number, are anonymously registered without the name or the address. In step 104, the donor registration module 46 registers information about the donors 14, such as the address, the phone number, the name, and the taxpayer identification number. In step 106, on a regular basis, the availability, the characteristics, the pick-up location(s) of the available surplus food items, and a predetermined time limit allowed for a recipient's response are registered by the donor surplus items module 47. In practice, after the recipient 12 positively responds to notifications of the selected items and/or approval code APV within the time limit, the approval code APV is sent to the recipient as described below in further detail. In step 108, when the recipient monitoring module 28 receives the food request FD_{REQ} from the recipients 12 (e.g., in the pull system), control proceeds to step 110. Otherwise, control proceeds to step 112.

In step 110, the recipient monitoring module 28 generates a donor search request DS_{REQ} based on the food request FD_{REQ}, and transmits the donor search request DS_{REQ} to the donor match module 30. In step 114, the donor match module 30 receives the donor search request DS_{IQ} from the recipient monitoring module 28, searches for the donor 14 based on the food request FD_{REQ}, the predetermined distance between the recipient 12 and the donor 14, and the priority level associated with the recipient. Similarly, in step 112, the donor match module 30 searches for the recipients 12 based on the registered parameters, the predetermined distance between the recipient 12 and the donor 14, and the priority level associated with the recipient.

In step 116, when there are too many qualified recipients 12 within the predetermined distance, control proceeds to step 118. Otherwise, control proceeds to step 120. In step 118, the donor match module 30 draws a predetermined number of recipients 12 based on the recipient's priority level. In step 120, the donor match module 32 generates the approval code APV and the associated pick-up location information for each corresponding surplus food item. In step 122, the search result module 32 notifies the recipient 12 of the selected food items and the corresponding pick-up location via the network 18 along with a first predetermined time limit for the recipient's response. In step 124, when the recipient 12 accepts the food items, control proceeds to step 126. Otherwise, control proceeds to step 128. For example, the recipient 12 has a choice of positively accepting or negatively rejecting the selected food items by pressing a button displayed on the recipient's device 16 within the first predetermined time limit. The recipient 12 presses a first button to accept or a second button to reject the food items.

Alternatively, the recipient 12 may respond to the notification of the selected items by transmitting an appropriate text message to the recipient monitoring module 28, e.g., “STOP” for a rejection/cancel signal or “OK” for an acceptance signal. If the recipient 12 does not respond within the first time limit, the selected items become no longer available for the recipient 12 and control proceeds to step 128. Further, the recipient 12 has an option to selectively respond for one or more surplus items as desired such that not all selected items are accepted by the recipient.

In step 126, the search result module 32 receives the approval code APV and the associated pick-up location information from the donor match module 30, and sends the approval code, the pick-up location, and a second predetermined time limit for the pick-up of the items to the recipient's device 16 via the network 18. While the first and second time limits are used for the recipient's response to the notification (e.g., 5 minutes) and the pick-up of the accepted items (e.g., 15 minutes), an extended first time limit can be used for both the response and the pick-up (e.g., 20 minutes).

In step 128, when the recipient response module 44 generates a cancel signal STOP for negatively responding or failing to respond to the items, the recipient monitoring module 28 receives the cancel signal STOP and resets the approval code APV, and then sets the selected surplus food items as available for the subsequent food requests.

In step 130, when the recipient 12 or anyone with the approval code APV arrives at the pick-up location within the second time limit, control proceeds to step 132. Otherwise, control proceeds to step 128. As similarly described in step 124, the recipient 12 has an optional choice of positively accepting or negatively rejecting the approval code APV. Similar methods illustrated in step 124 are employed here for the approval code APV.

In step 132, the recipient 12 presents the approval code APV received at step 126 to the donor 14 when picking up the food items at the pick-up location. In step 134, the donor 14 hands over the food items to the recipient 12. In step 136, the pick-up confirmation module 48 of the donor module 24 transmits the approval code APV to the donor monitoring module 34 as the confirmation signal CFM. In step 138, the donor monitoring module 34 receives the confirmation signal CFM from the pick-up confirmation module 48, and sets the selected surplus food items as unavailable for the subsequent food request. In step 140, the interface module 38 receives all transaction records, e.g., donations and accepted items, from other modules and stores the records in the central database 26 for subsequent retrieval.

In step 142, depending on the donor's accounting practice, when it is time to apply the tax benefits for the donor 14, control proceeds to step 144. Otherwise, control proceeds to step 148. In step 144, the accounting module 36 collects historical pick-up transactions of the recipients 12 that were recorded in the central database 26. Then, the accounting module 36 determines the amount of tax benefits BNF for the donor 14 based on at least one of the number of the pick-up transactions PICK, the predetermined value of the selected surplus food items VAL, and the multiplication of the number of the transactions and the predetermined value PICK*VAL. For example only, the amount of tax benefits BNF may be defined as provided by expression 1.

BNF=f{PICK,VAL,PICK*VAL} (1)

In step 146, the donor taxation module 50 receives the amount BNF from the accounting module 36, and reports the amount BNF as a tax benefit to the donor 14 and/or taxing authorities, e.g., IRS, charity, or the like, over a predetermined period. The method ends at step 148.

While preferred embodiments of the disclosure have been herein illustrated and described, it is to be appreciated that certain changes, rearrangements and modifications may be made therein without departing from the scope of the disclosure as defined by the appended claims.

What is claimed is:

1. A system for collecting and distributing one or more surplus items, comprising:
a central control module for distributing the surplus items donated by at least one donor to at least one recipient based on a recipient's qualification and an availability of the surplus items;
a donor registration module for registering the donor;
a donor surplus items module for registering the availability of the surplus items, characteristics of the surplus items, and a pick-up location of the surplus items on a predetermined time period;
a recipient registration module for registering the recipient when qualified and a plurality of parameters associated with the recipient;
a donor match module for matching the donor with the recipient, selecting the surplus items based on the parameters, and generating an approval code and a pick-up location for each surplus item; and
a search result module for notifying, via a network, the recipient of the surplus items, the pick-up location, and a predetermined time limit within which the recipient is allowed to respond to the notification and pick up the surplus items, wherein the approval code is sent to the recipient after the recipient positively responds to the notification within the time limit.

2. The system of claim 1, wherein the parameters include at least one of a predetermined distance between the recipient and the donor, one or more attributes of the surplus items, and a priority level associated with the recipient, the priority level being determined based on at least one of a physical condition and a number of family members or dependents of the recipient.

3. The system of claim 1, wherein the search result module generates at least one of map information and one or more pictures of the pick-up location.

4. The system of claim 1, wherein the donor match module draws at least one recipient that is located within a predetermined distance from the donor.

5. The system of claim 1, further comprising an item request module for generating an item request having the parameters based on at least one of dietary, belief-based, and medical reasons.

6. The system of claim 1, wherein the recipient registration module receives and registers at least one of a recipient's address, a recipient's phone number, a recipient's name, a government issued identifier, and a recipient's mobile device geographical positioning information.

7. The system of claim 1, wherein the donor registration module receives and registers at least one of a donor's address, a donor's email address, a donor's phone number, a donor's name, and a taxpayer identification number.

8. The system of claim 1, further comprising a recipient monitoring module for receiving an item request having the parameters, and generating a donor search request based on the item request, wherein the donor match module receives the donor search request and selects the surplus items based on the parameters.

9. The system of claim 8, further comprising a recipient response module for generating a cancel signal that cancels the approval code when the recipient rejects the selected surplus items or fails to respond within the time limit, wherein the recipient monitoring module receives the cancel signal and resets the approval code for the selected surplus items, and setting the selected surplus items as available for a subsequent item request.

10. The system of claim 1, further comprising a pick-up confirmation module for generating a confirmation signal of a pick-up of the selected surplus items by the recipient based on the approval code.

11. The system of claim 10, further comprising a donor monitoring module for receiving the confirmation signal from the pick-up confirmation module, and setting the selected surplus items as unavailable for a subsequent item request.

12. The system of claim 1, further comprising an accounting module for collecting historical pick-up transactions of the recipients, and determining an amount of tax benefits for the donor based on at least one of a number of the pick-up transactions, a predetermined value of the selected surplus items, and a multiplication of the number of the transactions and the predetermined value, all of which are associated with the donor.

13. The system of claim 12, further comprising a donor taxation module for regularly reporting the amount of tax benefits to the donor or another organization over a predetermined period.

14. A method for collecting and distributing one or more surplus items, comprising:
distributing the surplus items donated by at least one donor to at least one recipient based on a recipient's qualification and an availability of the surplus items;
registering the donor, the availability of the surplus items, characteristics of the surplus items, and a pick-up location of the surplus items on a predetermined time period;
registering the recipient when qualified and a plurality of parameters associated with the recipient;
matching the donor with the recipient and selecting the surplus items based on the parameters;
generating an approval code and a pick-up location for each surplus item; and
notifying, via a network, the recipient of the surplus items, the pick-up location, and a predetermined time limit within which the recipient is allowed to respond to the notification and pick up the surplus items, wherein the approval code is sent to the recipient after the recipient positively responds to the notification within the time limit.

15. The method of claim 14, further comprising:
including at least one of a predetermined distance between the recipient and the donor, one or more attributes of the surplus items, and a priority level associated with the recipient as the parameters;
determining the priority level based on at least one of a physical condition and a number of family members or dependents of the recipient;
generating at least one of map information and one or more pictures of the pick-up location;
drawing at least one recipient that is located within a predetermined distance from the donor; and
generating an item request having the parameters based on at least one of dietary, belief-based, and medical reasons.

16. The method of claim 14, further comprising:
registering at least one of a recipient's address, a recipient's phone number, a recipient's name, a government issued identifier, and a recipient's mobile device geographical positioning information; and
registering at least one of a donor's address, a donor's email address, a donor's phone number, a donor's name, and a taxpayer identification number.

17. The method of claim 14, further comprising:
receiving an item request having the parameters;
generating a donor search request based on the item request;
receiving the donor search request; and
selecting the surplus items based on the parameters.

18. The method of claim 14, further comprising:
generating a cancel signal that cancels the approval code when the recipient rejects the selected surplus items or fails to respond within the time limit;
receiving the cancel signal;
resetting the approval code for the selected surplus items; and
setting the selected surplus items as available for a subsequent item request.

19. The method of claim 14, further comprising:
generating a confirmation signal of a pick-up of the selected surplus items by the recipient based on the approval code;
receiving the confirmation signal; and
setting the selected surplus items as unavailable for a subsequent item request.

20. The method of claim 14, further comprising:
collecting historical pick-up transactions of the recipients;
determining an amount of tax benefits for the donor based on at least one of a number of the pick-up transactions, a predetermined value of the selected surplus items, and a multiplication of the number of the transactions and the predetermined value, all of which are associated with the donor; and
reporting the amount of tax benefits regularly to the donor or another organization over a predetermined period.
